(19) United States
(12) Patent Application Publication
(10) Pub. No.: US 2023/0371596 A1
(43) Pub. Date: Nov. 23, 2023

(54) AEROSOL GENERATION DEVICE AND INFRARED HEATER

(71) Applicant: SHENZHEN FIRST UNION TECHNOLOGY CO., LTD., Shenzhen City, Guangdong Province (CN)

(72) Inventors: JIAMAO LUO, Shenzhen City, Guangdong Province (CN); ZUQIANG QI, Shenzhen City, Guangdong Province (CN); BAOLING LEI, Shenzhen City, Guangdong Province (CN); ZHONGLI XU, Shenzhen City, Guangdong Province (CN); YONGHAI LI, Shenzhen City, Guangdong Province (CN)

(21) Appl. No.: 18/027,625

(22) PCT Filed: Sep. 22, 2021
(86) PCT No.: PCT/CN2021/119649

§ 371 Date: Mar. 21, 2023

(30) Foreign Application Priority Data
Sep. 22, 2020 (CN) 202022084145.8

(51) Int. Cl. A24F 40/46

(52) U.S. Cl. CPC A24F 40/46; A24F 40/57

(57) ABSTRACT

This application relates to the field of cigarette devices, and provides an aerosol generation device and an infrared heater. The aerosol generation device includes a chamber, configured to receive an aerosol forming substrate; and at least one infrared heater, including a plurality of carbon material heating tubes, where the plurality of carbon material heating tubes are constructed to heat the aerosol forming substrate received in the chamber in an infrared radiation manner. In this application, a plurality of carbon material heating tubes heat an aerosol forming substrate received in a chamber in an infrared radiation manner. Because infrared has a strong penetrability, temperatures inside and outside a cigarette may be distributed more evenly, a heating speed is higher, and fragrance is released more fully, thereby improving inhaling experience of a user.

### CROSS-REFERENCE TO RELATED APPLICATIONS

This application claims priority to Chinese Patent Application No. 202022084145.8, filed with the China National Intellectual Property Administration on Sep. 22, 2020 and entitled “AEROSOL GENERATION DEVICE AND INFRARED HEATER”, which is incorporated herein by reference in its entirety.

### TECHNICAL FIELD

Embodiments of this application relate to the field of cigarette device technologies, and in particular, to an aerosol generation device and an infrared heater.

### BACKGROUND

During use of smoking objects such as a cigarette or cigar, tobaccos are burnt to generate vapor. A product that releases compounds without burning has been tried to provide an alternative for the objects that burn tobaccos. An example of the products is a heat-not-burn product, which releases compounds by heating tobaccos rather than burning tobaccos.

In an existing heat-not-burn cigarette device, a resistive heating body is mainly used, and heat generated by the resistive heating body heats a cigarette in a transfer manner. Problems existing in the cigarette device are as follows: Cut tobacco in direct contact with the resistive heating body is at a high temperature, and is easily over-baked; while cut tobacco away from the resistive heating body is at a relatively low temperature, and is not baked fully. As a result, fragrance of the cigarette is not released fully, and inhalation taste is relatively poor.

### SUMMARY

This application provides an aerosol generation device and an infrared heater, aiming to resolve problems existing in an existing cigarette device that fragrance of a cigarette is not released fully and inhalation taste is relatively poor because there is a relatively large temperature gradient between the inside and the outside of the cigarette during heating of the cigarette.

An aspect of this application provides an aerosol generation device, configured to heat an aerosol forming substrate to generate an aerosol for inhalation, and including:
a chamber, configured to receive the aerosol forming substrate; and
at least one infrared heater, including a plurality of carbon material heating tubes, where the plurality of carbon material heating tubes are constructed to heat the aerosol forming substrate received in the chamber in an infrared radiation manner.

Another aspect of this application provides an infrared heater for an aerosol generation device, where the infrared heater includes a plurality of carbon material heating tubes; and the plurality of carbon material heating tubes are constructed to heat an aerosol forming substrate at least in an infrared radiation manner.

In the aerosol generation device and the infrared heater provided in this application, a plurality of carbon material heating tubes heat an aerosol forming substrate received in a chamber in an infrared radiation manner. Because infrared has a strong penetrability, temperatures inside and outside a cigarette may be distributed more evenly, a heating speed is higher, and fragrance is released more fully, thereby improving inhaling experience of a user.

### BRIEF DESCRIPTION OF THE DRAWINGS

One or more embodiments are described by way of example with reference to the corresponding figures in the accompanying drawings, and the exemplary descriptions are not to be construed as limiting the embodiments. Elements/modules and steps in the accompanying drawings that have same reference numerals are represented as similar elements/modules and steps, and unless otherwise particularly stated, the figures in the accompanying drawings are not drawn to scale.

FIG. 1 is a schematic diagram of an aerosol generation device according to an implementation of this application;

FIG. 2 is a schematic diagram of an aerosol generation device with a cigarette inserted according to an implementation of this application;

FIG. 3 is a schematic diagram of an infrared heater according to an implementation of this application;

FIG. 4 is a schematic exploded diagram of an infrared heater according to an implementation of this application;

FIG. 5 is a schematic diagram of a carbon material heating wire and a hollow tube in an infrared heater according to an implementation of this application;

FIG. 6 is a schematic diagram of a hollow tube in an infrared heater according to an implementation of this application;

FIG. 7 is a schematic diagram of an electrode connection member in an infrared heater according to an implementation of this application;

FIG. 8 is a schematic diagram of another electrode connection member in an infrared heater according to an implementation of this application;

FIG. 9 is a schematic diagram of another infrared heater according to an implementation of this application;

FIG. 10 is a schematic exploded diagram of another infrared heater according to an implementation of this application;

FIG. 11 is a schematic diagram of a semicircular hollow tube according to an implementation of this application;

FIG. 12 is a schematic diagram of a C-shaped hollow tube according to an implementation of this application; and

FIG. 13 is a schematic diagram of a U-shaped hollow tube according to an implementation of this application.

### DETAILED DESCRIPTION

For ease of understanding of this application, this application is described below in more detail with reference to accompanying drawings and specific implementations. It should be noted that, when an element is expressed as “being fixed to” another element, the element may be directly on the another element, or one or more intermediate elements may exist between the element and the another element. When an element is expressed as “being connected to” another element, the element may be directly connected to the another element, or one or more intermediate elements may exist between the element and the another element. The terms “upper”, “lower”, “left”, “right”, “inner”, “outer”, and similar expressions used in this specification are merely used for an illustrative purpose.

Unless otherwise defined, meanings of all technical and scientific terms used in this specification are the same as those usually understood by a person skilled in art of this application. Terms used in this specification of this application are merely intended to describe objectives of the specific implementations, and are not intended to limit this application. The term “and/or” used in this specification includes any or all combinations of one or more related listed items.

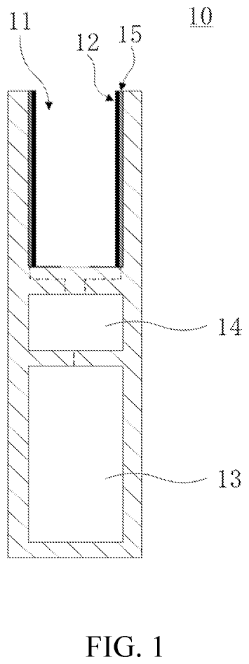

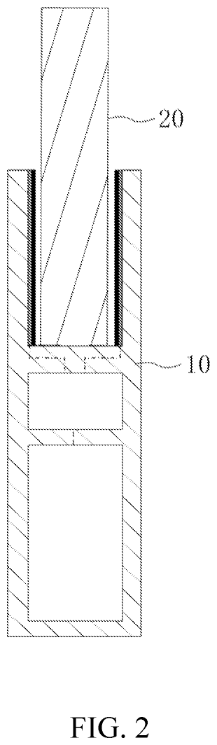

FIG. 1 and FIG. 2 show an aerosol generation device 10 provided in an implementation of this application and including the following:

A chamber 11 is configured to receive an aerosol forming substrate 20, for example, a cigarette.

The aerosol-forming substrate is a substrate that can release a volatile compound that can form an aerosol. The volatile compound can be released by heating the aerosol-forming substrate. The aerosol-forming substrate may be solid, or liquid, or components including solid and liquid. The aerosol-forming substrate may be loaded onto a carrier or support through adsorbing, coating, impregnating, or in other manners. The aerosol-forming substrate may conveniently be a part of the aerosol-forming article.

The aerosol-forming substrate may include nicotine. The aerosol-forming substrate may include tobacco, for example, a tobacco-containing material including a volatile tobacco aroma compound. The volatile tobacco aroma compound is released from the aerosol-forming substrate when heated. Preferably, the aerosol-forming substrate may include a homogeneous tobacco material. The aerosol-forming substrate may include at least one aerosol-forming agent, and the aerosol-forming agent may be any suitable known compound or a mixture of compounds. During use, the compound or the mixture of compounds facilitates condensing and stabilizing formation of the aerosol and is substantially resistant to thermal degradation at an operating temperature of an aerosol-forming system. Suitable aerosol-forming agents are well known in the related art and include, but are not limited to: polyol, such as triethylene glycol, 1,3-butanediol, and glycerol; ester of polyol, such as glycerol mono-, di- or triacetate; and fatty acid ester of mono-, di- or polycarboxylic acid, such as dimethyl dodecanedioate and dimethyl tetradecanedioate. Preferably, the aerosol forming agent is polyhydric ester or a mixture thereof, such as triethylene glycol, 1,3-butanediol, or most preferably, glycerol.

The infrared heater 12 includes a plurality of carbon material heating tubes; and the plurality of carbon material heating tubes are constructed to heat the aerosol forming substrate received in the chamber 11 at least in an infrared radiation manner.

A battery cell 13 provides power used for operating the aerosol generation device 10. For example, the battery cell 13 may provide power to heat the infrared heater 12. Moreover, the battery cell 13 may provide power required for operating other elements provided in the aerosol generation device 10.

The battery cell 13 may be a rechargeable battery or a disposable battery. The battery cell 13 may be, but is not limited to, a lithium iron phosphate (LiFePO4) battery. For example, the battery cell 13 may be a lithium cobaltate (LiCoO2) battery or a lithium titanate battery.

A circuit 14 may control an overall operation of the aerosol generation device 10. The circuit 14 not only controls operations of the battery cell 13 and the infrared heater 12, but also controls operations of other elements in the aerosol generation device 10. For example, the circuit 14 obtains information about a temperature of the infrared heater 12 sensed by a temperature sensor 123, and controls, according to the information, power provided by the battery cell 13 to the infrared heater 12.

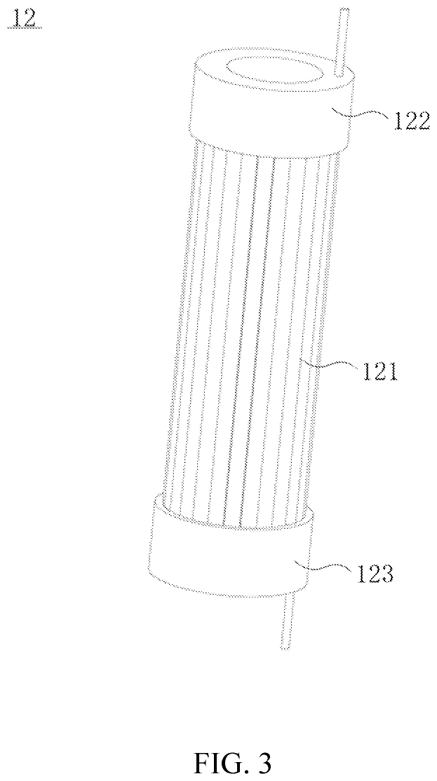

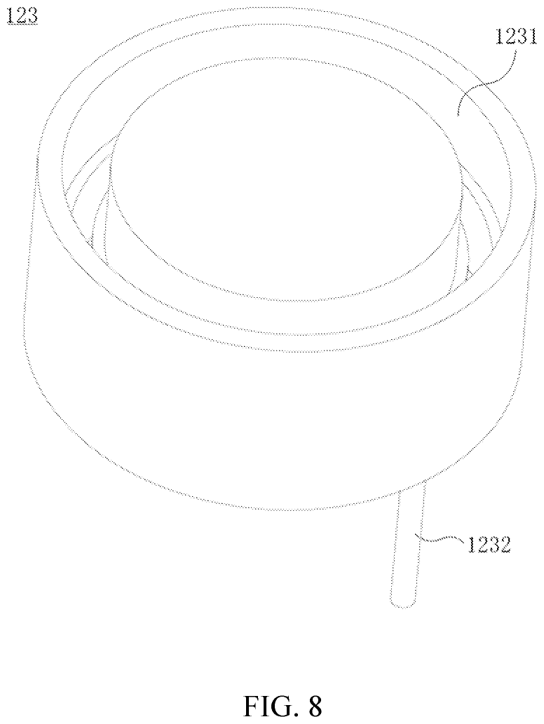

FIG. 3 and FIG. 8 show an infrared heater 12 according to an implementation of this application. The infrared heater 12 includes a plurality of hollow tubes 121, an electrode connection member 122, an electrode connection member 123, and a plurality of carbon material heating wires 124.

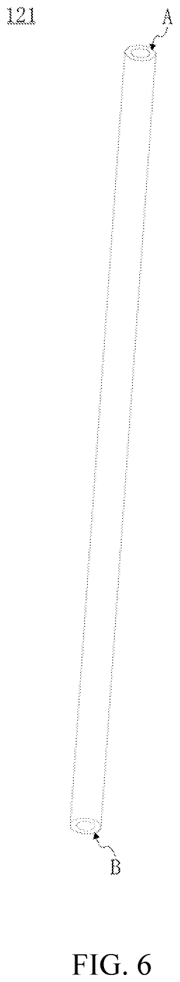

As shown in FIG. 6, the hollow tube 121 includes a first end A and a second end B opposite to each other, and the hollow tube 121 extends in a longitudinal direction between the first end A and the second end B and is hollow inside to form a through-hole for accommodating the carbon material heating wire 124. The hollow tube 121 may be made of a high-temperature resistant and transparent material such as quartz glass, ceramic, or mica, and may alternatively be made of another material with a relatively high infrared transmittance, for example, a high-temperature resistant material with an infrared transmittance above 95%. Specifically, this is not limited herein. The outer diameter of the hollow tube 121 ranges from 0.3 mm to 3 mm, and preferably from 0.5 mm to 2 mm.

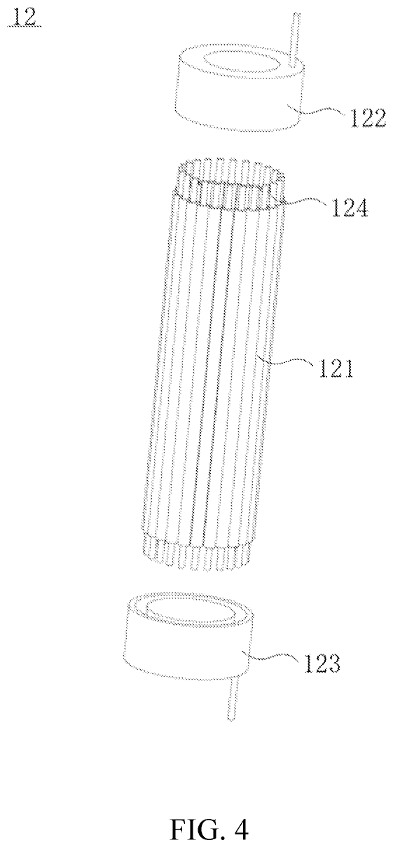

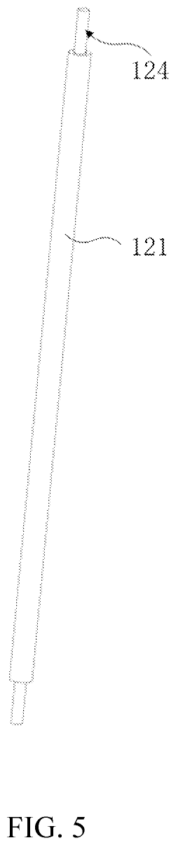

As shown in FIG. 3 to FIG. 4, In this example, the hollow tube 121 is in a shape of—; and the plurality of hollow tubes 121 are arranged in a circumferential direction of the chamber 11. As shown in FIG. 5, each hollow tube 121 accommodates at least one carbon material heating wire 124 through a through-hole, to form one carbon material heating tube. In this way, after the plurality of carbon material heating tubes formed by the plurality of hollow tubes 121 and the plurality of carbon material heating wires 124 are arranged in the circumferential direction of the chamber 11, infrared may be radiated to the chamber 11 to heat the aerosol forming substrate received in the chamber 11.

The carbon material may be made of a derivative and a compound having carbon as some or all component elements and including, but not limited to, one or more of carbon nanotube, graphene, and carbon fiber. In this example, the carbon material heating wire 124 may be formed by twisting one or more carbon fiber wires.

In this example, the plurality of carbon material heating tubes formed by the plurality of hollow tubes 121 and the plurality of carbon material heating wires 124 are constructed to dependently start. Specifically, one end of each of the plurality of carbon material heating wires 124 is coupled to a power supply (for example, an anode) through the electrode connection member 122, and another end is coupled to the power supply (for example, a cathode) through the electrode connection member 123. The electrode connection member 122 and the electrode connection member 123 may be each made of metal or alloy with a low resistivity, such as silver, gold, palladium, platinum, copper, nickel, molybdenum, tungsten, niobium, or an alloy material of the foregoing metals.

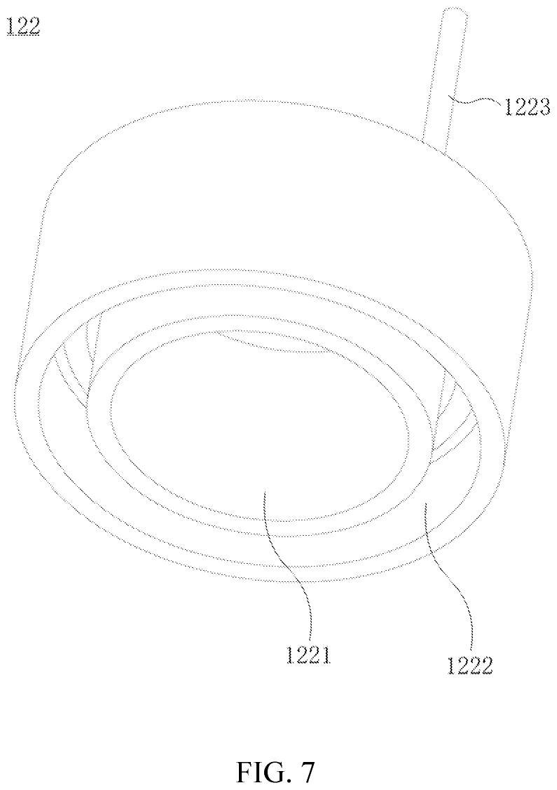

As shown in FIG. 7, the electrode connection member 122 includes a through-hole 1221, a fixing portion 1222, and an extend portion 1223. The through-hole 1221 keeps communication with the chamber 11. The fixing portion 1222 is recessed from an end surface of the electrode connection member 122 toward another end surface, one end of each of the plurality of hollow tubes 121 may be fixed in the fixing portion 1222, and one end of the carbon material heating wire 124 extends out from one end of the hollow tube 121 and comes into contact with the fixing portion 1222 to form an electrical connection. The extending portion 1223 extends from another end surface of the electrode connection member 122 in a direction away from the electrode connection member 122, and the extending portion 1223 is configured to be coupled to the battery cell 13. As shown in FIG. 8, different from the electrode connection member 122, the electrode connection member 123 includes only a fixing portion 1231 and an extending portion 1232, another end of each of the plurality of hollow tubes 121 may be fixed in the fixing portion 1231, and another end of the carbon material heating wire 124 extends out from another end of the hollow tube 121 and comes into contact with the fixing portion 1222 to form an electrical connection. For the extending portion 1232, reference may be made to the description of the extending portion 1223, and details are not described herein again.

Different from the foregoing example, in another example, after each hollow tube 121 accommodates at least one carbon material heating wire 124 through the through-hole, two ends of the carbon material heating wire 124 may each maintain an electrical connection through an electrical connection member, that is, 2N electrical connection members are configured for N hollow tubes 121. When being coupled to the battery cell 13, the plurality of carbon material heating tubes formed in this way may be constructed to dependently start, and may alternatively be constructed to independently start. Further, two ends of each hollow tube 121 may be each sealed through a sealing member, an electrical connection member is electrically connected to the carbon material heating wire 124 through the sealing member, and each hollow tube 121 is filled with an inert gas and/or vacuumized, to avoid oxidization of the carbon material heating wire 124.

Referring to FIG. 1 again, the infrared heater 12 further includes a holding member 15, and the holding member 15 is configured to hold the plurality of carbon material heating tubes. The holding member 15 may be but is not limited to a hollow tubular structure member, and the hollow tubular structure member is arranged on a periphery of the plurality of carbon material heating tubes. Further, an infrared reflection layer may be further formed on inner surface of the hollow tubular structure member (a surface facing the plurality of carbon material heating tubes), and the infrared reflection layer may reflect the infrared radiated by the plurality of carbon material heating tubes to the chamber, to improve infrared heating efficiency. The infrared emitting layer may be made of one or more of gold, silver, nickel, aluminum, gold alloy, silver alloy, nickel alloy, aluminum alloy, gold oxide, silver oxide, nickel oxide, aluminum oxide, titanium oxide, zinc oxide, and cerium dioxide.

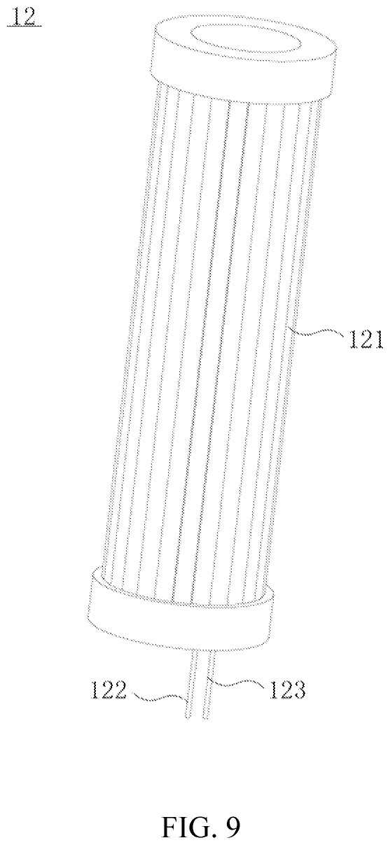

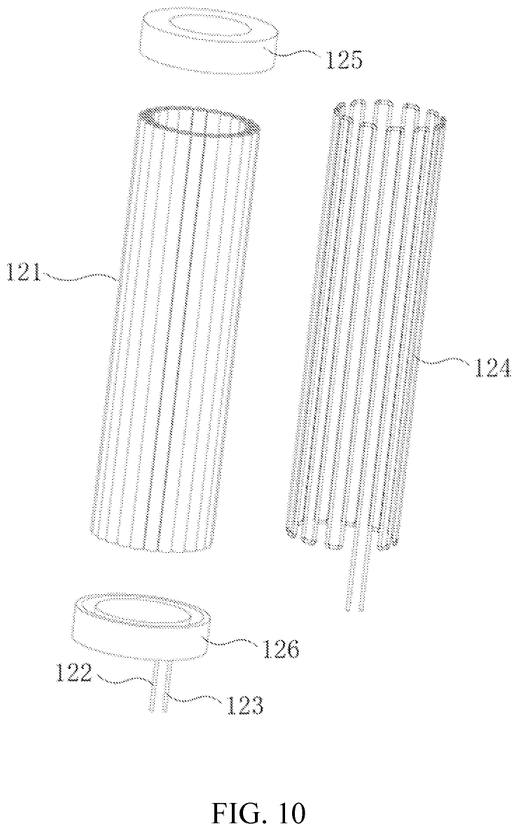

FIG. 9 and FIG. 10 show another infrared heater 12 according to an implementation of this application. Different from FIG. 3 to FIG. 8, the infrared heater 12 includes a plurality of hollow tubes 121, a carbon material heating wire 124, an electrode connection member 122, an electrode connection member 123, a fixing base 125, and a fixing base 126;

each hollow tube 121 accommodates a part of the carbon material heating wire 124, to form one of a plurality of carbon material heating tubes; and

the fixing base 125 has a structure similar to that of the electrode connection member 122 in FIG. 3 to FIG. 8, and a difference is that the fixing base 125 is made of a high-temperature resistant insulating material. The fixing base 126 has a structure similar to that of the electrode connection member 123 in FIG. 3 to FIG. 8, and a difference is that the fixing base 126 is also made of a high-temperature resistant insulating material, does not have the extending portion 1232, and is provided with via-holes of the electrode connection member 122 and the electrode connection member 123.

The electrode connection member 122 is electrically connected to one end of the carbon material heating wire 124, and the electrode connection member 123 is electrically connected to another end of the carbon material heating wire 124. Specifically, the electrode connection member 122 and one end of the carbon material heating wire 124 may be twined closely together and then tied tightly, for example, tied tightly with a molybdenum wire; and the electrode connection member 123 and another end of the carbon material heating wire 124 are in a similar case.

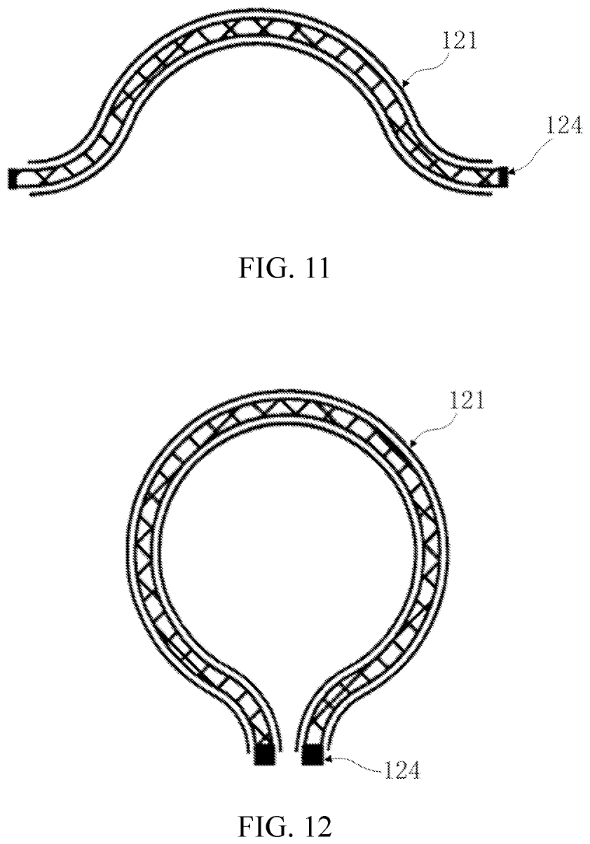

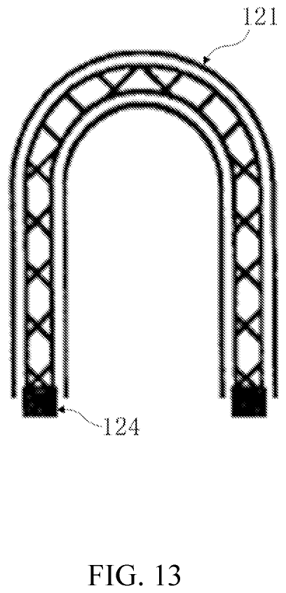

FIG. 11 to FIG. 13 are schematic diagrams of a semicircular hollow tube 121, a C-shaped hollow tube 121, and a U-shaped hollow tube 121 according to implementations of this application respectively. With hollow tubes 121 in the structures, a plurality of carbon material heating tubes formed by a plurality of hollow tubes 121 and a carbon material heating wire 124 may be arranged in an axial direction of a chamber 11, to radiate infrared to the chamber 11 and then heat an aerosol forming substrate received in the chamber 11.

It should be noted that, the foregoing embodiment is described with only one infrared heater 12 as an example. In another example, the aerosol generation device 10 may include a first infrared heater and a second infrared heater, and the first infrared heater and the second infrared heater are constructed to independently start to implement segmented heating.

For structures of the first infrared heater and the second infrared heater, reference may be made to the foregoing content. Details are not described herein. The first infrared heater and the second infrared heater may be arranged in an axial direction of a chamber 11, to heat different parts in an axial direction of an aerosol forming substrate, and then implement segmented heating; and may alternatively be arranged in a circumferential direction of the chamber 11, to heat different parts in the circumferential direction of the aerosol forming substrate, and then implement segmented heating.

It should be further noted that, in another example, it is also possible that the plurality of carbon material heating tubes are constructed to be insertable into the aerosol forming substrate received in the chamber.

It should be noted that, this specification of this application and the accompanying drawings thereof illustrate preferred embodiments of this application. However, this application can be implemented in various different forms, and is not limited to the embodiments described in this specification. These embodiments are not intended to be an additional limitation on the content of this application, and are described for the purpose of providing a more thorough and comprehensive understanding of the content disclosed in this application. Moreover, the foregoing technical features are further combined to form various embodiments not listed above, and all such embodiments shall be construed as falling within the scope of this application. Further, a person of ordinary skill in the art may make improvements or variations according to the above descriptions, and such improvements and variations shall all fall within the protection scope of the appended claims of this application.

1. An aerosol generation device, configured to heat an aerosol forming substrate to generate an aerosol for inhalation, and comprising:
a chamber, configured to receive the aerosol forming substrate; and
at least one infrared heater, comprising a plurality of carbon material heating tubes, wherein the plurality of carbon material heating tubes are constructed to heat the aerosol forming substrate received in the chamber in an infrared radiation manner.

2. The aerosol generation device according to claim 1, wherein the plurality of carbon material heating tubes are constructed to independently start.

3. The aerosol generation device according to claim 1, wherein the plurality of carbon material heating tubes are constructed to dependently start.

4. The aerosol generation device according to claim 3, wherein the infrared heater comprises a plurality of hollow tubes, a carbon material heating wire, a first electrode connection member, and a second electrode connection member;
each hollow tube accommodates a part of the carbon material heating wire, to form one of the plurality of carbon material heating tubes; and
the first electrode connection member is electrically connected to one end of the carbon material heating wire, and the second electrode connection member is electrically connected to another end of the carbon material heating wire.

5. The aerosol generation device according to claim 3, wherein the infrared heater comprises a plurality of hollow tubes, a plurality of carbon material heating wires, a third electrode connection member, and a fourth electrode connection member;
each hollow tube accommodates at least one carbon material heating wire, to form one of the plurality of carbon material heating tubes; and
the third electrode connection member is electrically connected to one end of each of the plurality of carbon material heating wires, and the fourth electrode connection member is electrically connected to another end of each of the plurality of carbon material heating wires.

6. The aerosol generation device according to claim 2, wherein any one of the plurality of carbon material heating tubes comprises a hollow tube, at least one carbon material heating wire, a fifth electrode connection member, and a sixth electrode connection member; and
the at least one carbon material heating wire is accommodated in the hollow tube, the fifth electrode connection member is electrically connected to one end of the at least one carbon material heating wire, and the sixth electrode connection member is electrically connected to another end of the at least one carbon material heating wire.

7. The aerosol generation device according to claim 1, wherein the carbon material heating tube is in a shape of—; and the plurality of carbon material heating tubes are arranged in a circumferential direction of the chamber, to radiate infrared to the chamber to heat the aerosol forming substrate.

8. The aerosol generation device according to claim 1, wherein the carbon material heating tube is in a shape of at least one of a semi-circle, U, and C; and the plurality of carbon material heating tubes are arranged in an axial direction of the chamber, to radiate infrared to the chamber to heat the aerosol forming substrate.

9. The aerosol generation device according to claim 1, wherein the infrared heater comprises a holding member, and the holding member is configured to hold the plurality of carbon material heating tubes.

10. An infrared heater for an aerosol generation device, wherein the infrared heater comprises a plurality of carbon material heating tubes; and the plurality of carbon material heating tubes are constructed to heat an aerosol forming substrate at least in an infrared radiation manner.

11. The aerosol generation device according to claim 3, wherein any one of the plurality of carbon material heating tubes comprises a hollow tube, at least one carbon material heating wire, a fifth electrode connection member, and a sixth electrode connection member; and
the at least one carbon material heating wire is accommodated in the hollow tube, the fifth electrode connection member is electrically connected to one end of the at least one carbon material heating wire, and the sixth electrode connection member is electrically connected to another end of the at least one carbon material heating wire.

12. The aerosol generation device according to claim 2, wherein the carbon material heating tube is in a shape of—; and the plurality of carbon material heating tubes are arranged in a circumferential direction of the chamber, to radiate infrared to the chamber to heat the aerosol forming substrate.

13. The aerosol generation device according to claim 2, wherein the carbon material heating tube is in a shape of at least one of a semi-circle, U, and C; and the plurality of carbon material heating tubes are arranged in an axial direction of the chamber, to radiate infrared to the chamber to heat the aerosol forming substrate.

14. The aerosol generation device according to claim 2, wherein the infrared heater comprises a holding member, and the holding member is configured to hold the plurality of carbon material heating tubes.

15. The aerosol generation device according to claim 3, wherein the carbon material heating tube is in a shape of—; and the plurality of carbon material heating tubes are arranged in a circumferential direction of the chamber, to radiate infrared to the chamber to heat the aerosol forming substrate.

16. The aerosol generation device according to claim 3, wherein the carbon material heating tube is in a shape of at least one of a semi-circle, U, and C; and the plurality of carbon material heating tubes are arranged in an axial direction of the chamber, to radiate infrared to the chamber to heat the aerosol forming substrate.

17. The aerosol generation device according to claim 3, wherein the infrared heater comprises a holding member, and the holding member is configured to hold the plurality of carbon material heating tubes.
